(19) United States
(12) Patent Application Publication
(10) Pub. No.: US 2016/0109086 A1
(43) Pub. Date: Apr. 21, 2016

(54) VEHICLE LAMP

(71) Applicant: HYUNDAI MOTOR COMPANY, Seoul (KR)

(72) Inventor: Jik Soo SHIN, Incheon (KR)

(21) Appl. No.: 14/620,095

(22) Filed: Feb. 11, 2015

(30) Foreign Application Priority Data
Oct. 21, 2014 (KR) 10-2014-0142311

(51) Int. Cl. F21S 8/10

(52) U.S. Cl. CPC F21S 48/232; F21S 48/214; F21S 48/2212; F21S 48/31

(57) ABSTRACT

A vehicle lamp includes a light source for generating light which has a set movement path. At least one reflector is provided on the movement path of the light generated by the light source. A scatterer is disposed on the movement path of the light generated by the light source to scatter the light such that the movement path of the light is visible.

### CROSS-REFERENCE(S) TO RELATED APPLICATIONS

The present application claims the benefit priority to Korean Patent Application No. 10-2014-0142311 filed on Oct. 21, 2014, the entire contents of which application are incorporated herein for all purposes by this reference.

### TECHNICAL FIELD

The present disclosure relates to a vehicle lamp, and particularly, to a vehicle lamp which forms continuous and repetitive patterns using one light source.

### BACKGROUND

A variety of lamps provided in a vehicle indicate a position of the vehicle on the periphery and a current traveling state and a traveling direction of the vehicle backward and forward under various situations so that a driver secures a clear view.

From among these lamps, a rear combination lamp installed to a host vehicle informs rear vehicles behind the host vehicle of a current traveling state and a traveling direction of the host vehicle. One rear combination lamp comprises a tail lamp for indicating the presence of the host vehicle during night traveling, a brake lamp for informing braking of the hot vehicle, a turn signal lamp for indicating left and right turning of the host vehicle, a backup lamp for indicating backward movement of the host vehicle, etc.

In recent years, importance of design and visibility of the rear combination lamp have been emphasized. However, the conventional rear combination lamp has design limitations thereof since the rear combination lamp has at least one bulb and a reflector around the same so as to reflect the rear with light.

In order to resolve this problem, there is a method for realizing the rear combination lamp using a plurality of LEDs which enables realizing more various designs compared to when one bulb is used and further improving visibility compared to the related art.

However, according to the rear combination lamp using the LEDs, an excessive number of LEDs is used, a plurality of LEDs according to realization of lighting of various colors and forms need to be prepared, and a design is limited to a 2D manner.

The matters described as the related art have been provided only for assisting the understanding for the background of the present disclosure and should not be considered as corresponding to the related art already known to those skilled in the art.

### SUMMARY

An aspect of the present inventive concept provides a vehicle lamp which includes a light source for generating light which has a specific movement path, and a scatterer forming a movement path of the light which has a pattern set by reflection of the light generated by the light source so that the movement path of the light is visible from outside.

Other objects and advantages of the present disclosure can be understood by the following description, and become apparent with reference to the embodiments of the present inventive concept. Also, it is obvious to those skilled in the art to which the present disclosure pertains that the objects and advantages of the present disclosure can be realized by the means as claimed and combinations thereof.

In accordance with an embodiment of the present inventive concept, a vehicle lamp includes a light source for generating light which has a set movement path. At least one reflector is provided on the movement path of the light generated by the light source. A scatterer is disposed on the movement path of the light generated by the light source to scatter the light such that the movement path of the light is visible.

The light source may generate laser beams.

The reflector may be provided in plural numbers, and the plurality of reflectors may be arranged in a set pattern formed by the movement path of the light.

The set pattern may be provided in plural numbers, and the plurality of set patterns may have continuous and repetitive form.

The scatterer may be in a form of any one of gas, liquid, solid, and gel and include particles for scattering the light.

The vehicle lamp may include a housing of which an inner wall surface is provided with the reflector, the scatterer may be filled in the housing, and the movement path of the light may be formed in the scatterer along the reflector.

The housing may be sealed and have a transparent front surface. The light from the light source may be incident on a rear surface of the housing, and the reflector may be provided at a side surface of the housing.

All of the front, rear, and side surfaces of the housing may be transparent.

The reflector may be installed to entirely cover the rear surface and the side surface of the inner wall surface of the housing.

The housing may have a polygonal shape at the side surface thereof and have a length in forward and rearward directions. The reflector may be provided on each surface of the polygonal-shaped side surface along an entire or partial length thereof.

The reflector may be mounted to the inner wall surface of the housing.

The housing may further include a light receiving portion to receive light from the light source at a position at which the light from the light source reaches the inner wall portion of the housing and to prevent the light from being reflected from the position.

### BRIEF DESCRIPTION OF THE DRAWINGS

FIGS. 1A to 1C are views illustrating a configuration of a vehicle lamp according to a first embodiment of the present inventive concept.

FIGS. 2A to 2C are views illustrating a configuration of a vehicle lamp according to a second embodiment of the present inventive concept.

FIGS. 3A to 3C are views illustrating a configuration of a vehicle lamp according to a third embodiment of the present inventive concept.

FIGS. 4A to 4C are views illustrating a configuration of a vehicle lamp according to a fourth embodiment of the present inventive concept.

### DETAILED DESCRIPTION

A vehicle lamp according to exemplary embodiments of the present inventive concept will be described below in more detail with reference to the accompanying drawings. The present inventive concept may, however, be embodied in different forms and should not be construed as limited to the embodiments set forth herein. Rather, these embodiments are provided so that this disclosure will be thorough and complete and will fully convey the scope of the present disclosure to those skilled in the art. Throughout the disclosure, like reference numerals refer to like parts throughout the various figures and embodiments of the present inventive concept.

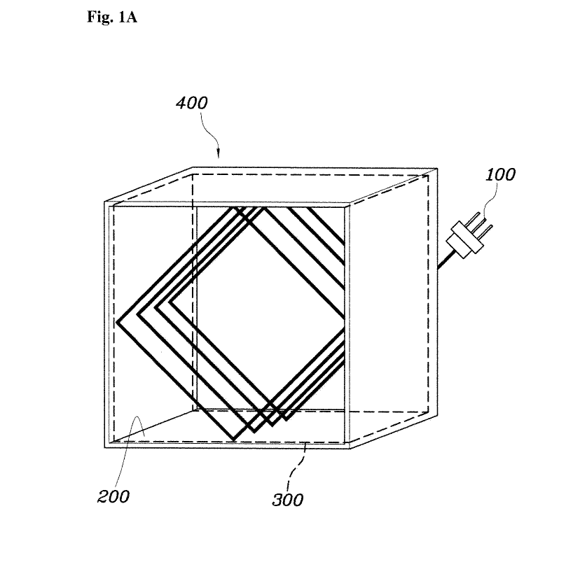

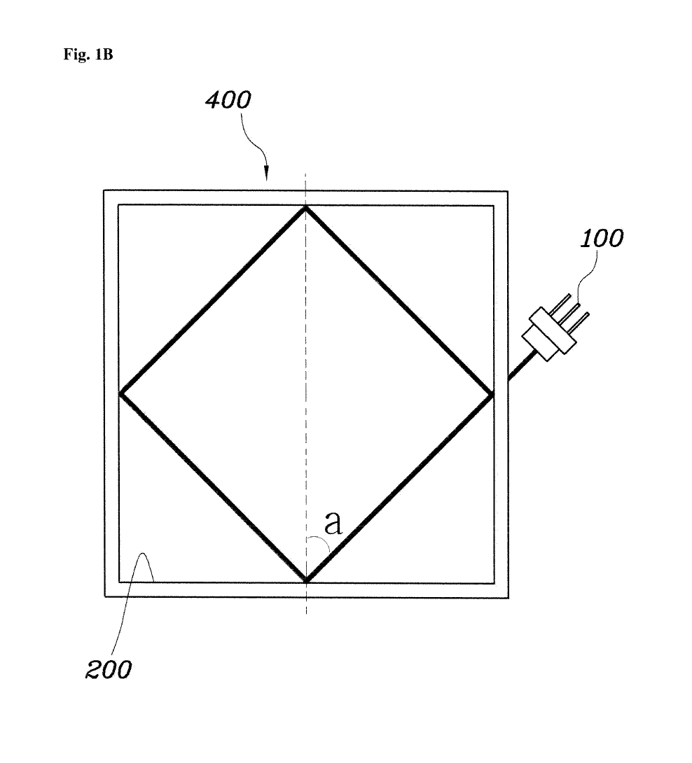

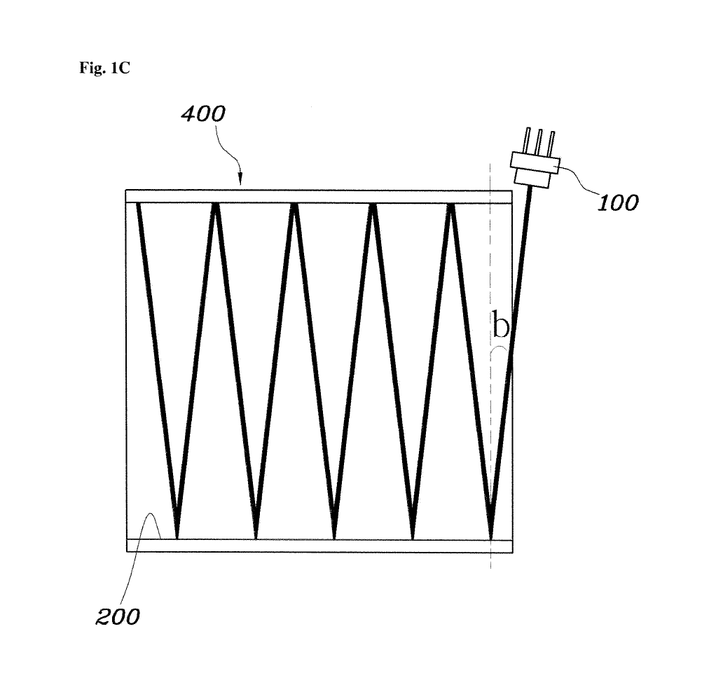

FIGS. 1A to 4C are views illustrating a configuration of a vehicle lamp according to first to fourth embodiments of the present inventive concept. The vehicle lamp includes a light source 100 for generating light having a set movement path. At least one reflector 200 is provided on the movement path of the light generated by the light source 100. A scatterer 300 is disposed on the movement path of the light generated by the light source 100 to scatter the light such that the movement path of the light is visible.

Specifically, the light source 100 may be a laser diode generating laser beams. Any light source may be used as the light source 100 capable of generating linear light to be radiated to a specific path even though the light source 100 does not necessarily generate laser beams. A light source which generates light in a certain distribution form may also be used. The movement path may be variously set in a linear manner so as to be directed forward of the light source 100. The movement path may be variously set according to a position and reflection directions of the light source 100. Embodiments of the movement path of the light will be described later.

Here, only one reflector 200 may be provided, but a plurality of reflectors 200 may be provided such that the movement path of the light forms a set pattern. That is, the plurality of reflectors 200 may continuously transfer the light emitted from the light source 100 in such a manner that one reflector 200 of the plurality of reflectors, on which light emitted from the light source 100 is first incident, reflects the incident light to a next reflector 200, so that the movement path forms the continuous set pattern.

The set pattern may be variously formed according to a position of the one reflector 200, an incident angle of light in the reflector 200, a position of the light source 100, etc. Thus, the set pattern may be provided in plural numbers in which the plurality of set patterns continuously and repeatedly formed.

The plurality of set patterns continuously formed at regular intervals provide images having more depth. Accordingly, the light source 100 for realization of the plurality of set patterns need not be provided in plural since the reflector 200 is arranged in a way that each set pattern is formed in a single line, thereby decreasing production line and manufacturing cost. However, the present disclosure is not limited in that the plurality of light sources 100 may be used to increase brightness of the overall pattern.

One reflector 200 may be installed only at a required position of reflection by using a separate support structure to form the set pattern, or the plurality of reflectors 200 may be provided in one combined structure as in various embodiments to be described later.

In addition, the reflector 200 may be an object such as a mirror or a metal panel for reflection of light so as to be fixed at a required position, or may be installed by applying a reflective solution to a separate panel. In addition, any form may be used as the reflector 200 so long as the light from the light source reflects.

The scatterer 300 may be in one of gas, liquid, solid, and gel form including particles for scattering light. In more detail, the scatterer 300 may be provided along the entirety or a portion of the movement path of the light such that the entirety or a portion of the movement path of the light is present within the scatterer 300, or may be formed over a space in which the movement path of the light is formed instead of selective providing the scatterer 300 along the movement path of the light.

When the scatterer 300 is in the gas or liquid form, a housing 400 accommodating a gas or a liquid is provided in the vehicle lamp such that the scatterer 300 may be accommodated in a sealed space. The entirety or a portion of the housing 400 is made of a transparent material so that the movement path of the light moving in the scatterer 300 is visible from outside.

In addition, the scatterer 300 may include particles for scattering light therein. When the scatterer 300 is in the gas form, the gas including fine dust, a foggy gas such as vapor or dry ice, or the like may be used as the scatterer 300. When the scatterer 300 is in the liquid form, the scatterer 300 may include particles such as ink, milk, or bubbles for scattering the light.

When the scatterer 300 is in the solid or gel form, the housing 400 may be provided in the vehicle lamp, similar to the scatterer 300 formed in the gas or liquid. In addition, the scatterer 300 may also be connected to a vehicle body to be supported through a separate structure for fixing the scatterer 300, instead providing the housing 400.

When the scatterer 300 is in the solid form, a clear plastic having fine particles or bubbles therein may be used as the scatterer 300. When the scatterer 300 is in the gel form, a transparent or semitransparent aerogel may be used as the scatterer 300.

The above scatterer 300 is, by way of examples only, illustrated and should not be construed as limited to the embodiments set forth herein. Any substance or structure may be used as the scatterer 300 so long as light from the light source 100 is reflected and a movement path of the light is visible from the outside.

A vehicle lamp according to the first embodiment of the present inventive concept will be described in more detail with reference to FIGS. 1A to 1C. FIG. 1A is a perspective view of a vehicle lamp according to the first embodiment of the present inventive concept, FIG. 1B is a front view of the vehicle lamp of FIG. 1A, and FIG. 1C is a side view of the vehicle lamp of FIG. 1A.

In the first embodiment of the present inventive concept, the reflector 200 may be installed at an inner wall portion of the housing 400, the scatterer 300 may be filled in the housing 400, and the movement path of the light may be provided along the reflector 200 and formed in the scatterer 300.

The housing 400 may have a hexahedral structure to seal and have a front surface which is transparent at the entirety or a portion thereof. Light from the light source 100 may be incident on a rear surface of the housing 400, and the reflector 200 may be installed on a side surface of the housing 400.

The reflector 200 may be provided so as to entirely cover the side surface of the inner wall surface of the housing 400, or may also be selectively provided only at a position at which light is reflected as shown in FIGS. 1A to 1C. Although a case in which a reflective solution is applied to the inner wall portion of the housing 400 so as to serve as the reflector 200 is described in the first to fourth embodiments, a reflective panel or the like may also be installed instead of the above case. Alternatively, the inner wall surface itself of the housing 400 may also function as the reflector 200. This structure may be similarly applied to the second to fourth embodiments to be described later.

When the reflector 200 entirely covers the side surface, the position of the reflector 200 does not need to be readjusted even though an incident angle of light from the light source 100 varies, thereby improving easiness of adjustment and design of freedom. When the reflector 200 is provided selectively only at a position at which light is reflected, cost due to installation of the reflector 200 may be reduced.

In addition, the reflector 200 may be installed on the rear surface of the housing 400. When the reflector 200 is installed on the rear surface of the housing 400, a portion of light scattered by the scatterer 300 may reflect from the rear surface and radiate forward. In this case, aesthetics of the lamp can be improved, and quantity of light can be increased.

In addition, all of the front, rear, and side surfaces of the housing 400 may be transparent or semitransparent, or the front, rear, and side surfaces of the housing 400 may be partially transparent or semitransparent. Through such a structure, the shape formed by overlapping of the plurality of set patterns as in the perspective view of FIG. 1A is visible at a wider angle view.

The shapes and number of the set patterns formed by the movement path of the light may vary according the incident angle of the light from the light source 100. As shown in FIG. 1C, more set patterns may be realized at dense intervals as an incident angle b formed between an imaginary break line vertical to the inner wall portion of the housing 400 and light radiated forward is decreased. Fewer set patterns may be realized at wider intervals as the incident angle b of light radiated forward is increased.

In addition, as shown in FIG. 1B, an incident angle a formed between an imaginary dotted line vertical to the inner wall portion of the housing 400 and light radiated laterally is related to a shape of the set pattern. In the first embodiment, the incident angle of light from the light source 100 is set such that the light from the light source 100 passes a center of each surface of the housing 400 having a square shape at the side thereof, as shown in FIG. 1B. Thus, a set pattern having the square shape is realized, and the set square patterns are repeatedly formed while the light moves forward.

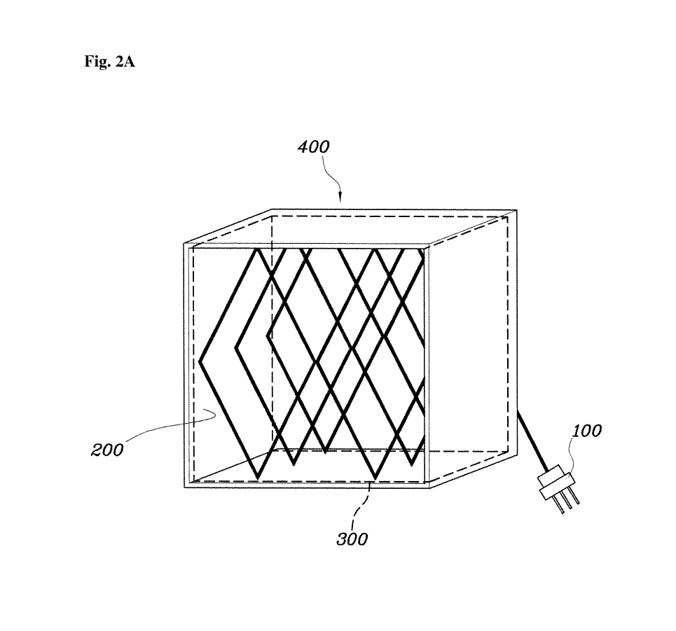

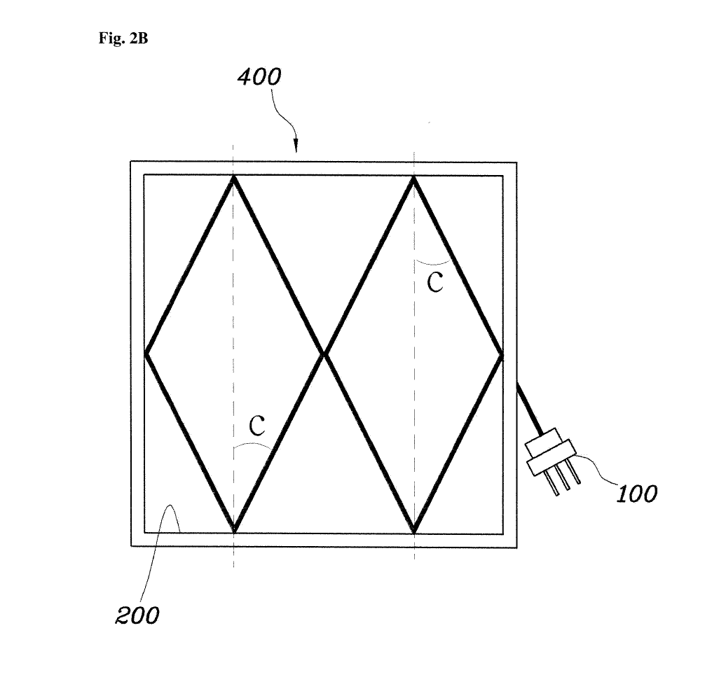

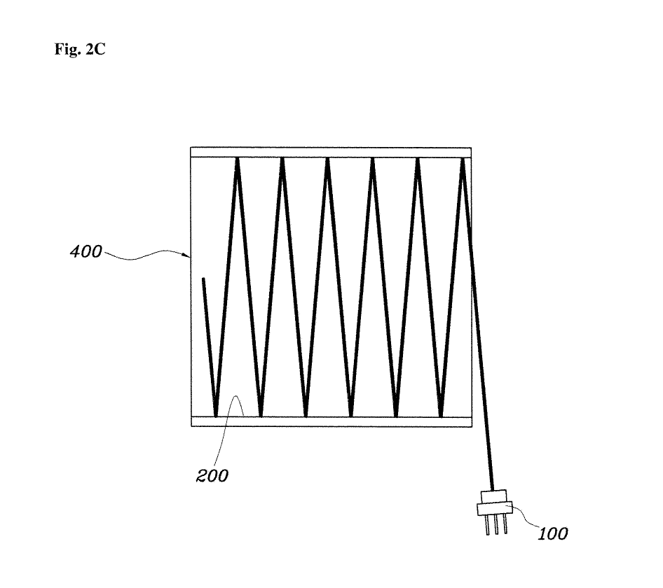

On the other hand, FIGS. 2A to 2C show the vehicle lamp according to the second embodiment of the present inventive concept. FIG. 2A is a perspective view of the vehicle lamp according to the second embodiment of the present inventive concept, FIG. 2B is a front view of the vehicle lamp of FIG. 2A, and FIG. 2C is a side view of the vehicle lamp of FIG. 2A.

The second embodiment has the same structure as the first embodiment, except that an incident angle c formed between an imaginary dotted line vertical to the inner wall portion of the housing 400 and light radiated laterally from the light source 100 differs from that of the first embodiment, as shown in FIG. 2B.

In the second embodiment, the incident angle c of light radiated laterally is less than that of the first embodiment, and thus, the light is reflected from one-fourth position or one-half position of each surface. As a result, a pair of set patterns having a diamond shape instead of the square shape in the first embodiment may be realized.

As such, the shape of the set pattern and the number of repeated set patterns may vary according to a shape of the incident angle.

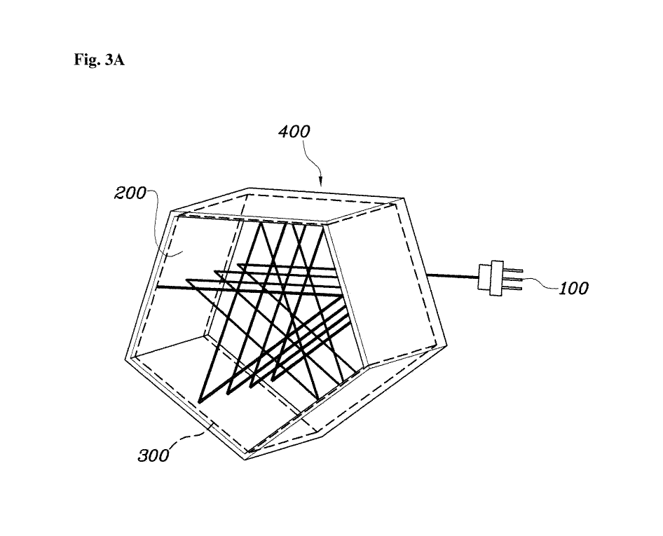

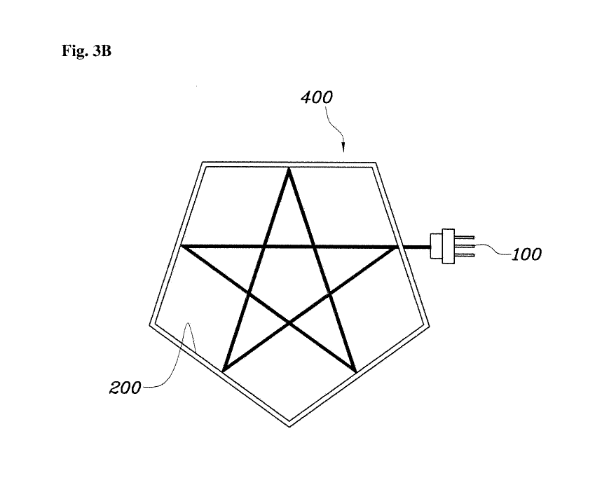

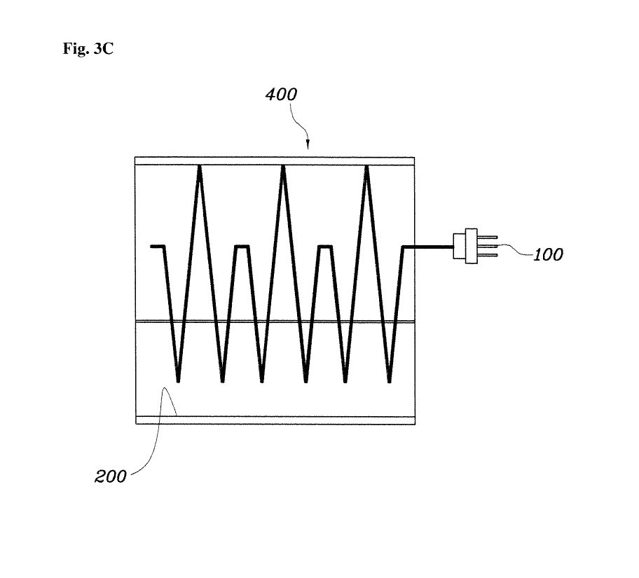

FIGS. 3A to 3C show the vehicle lamp according to the third embodiment of the present inventive concept. FIG. 3A is a perspective view of the vehicle lamp according to the third embodiment of the present inventive concept, FIG. 3B is a front view of the vehicle lamp of FIG. 3A, and FIG. 3C is a side view of the vehicle lamp of FIG. 3A.

The third embodiment has the same structure as the first embodiment, except that the housing 400 has a pentagonal shape at the side surface thereof instead of the housing 400 having the hexahedral shape. Here, light from the light source 100 may be reflected toward a center of each side surface.

In this case, a set pattern having a star shape may be realized, and a plurality of set patterns may be continuously formed according to the incident angle of light radiated forward.

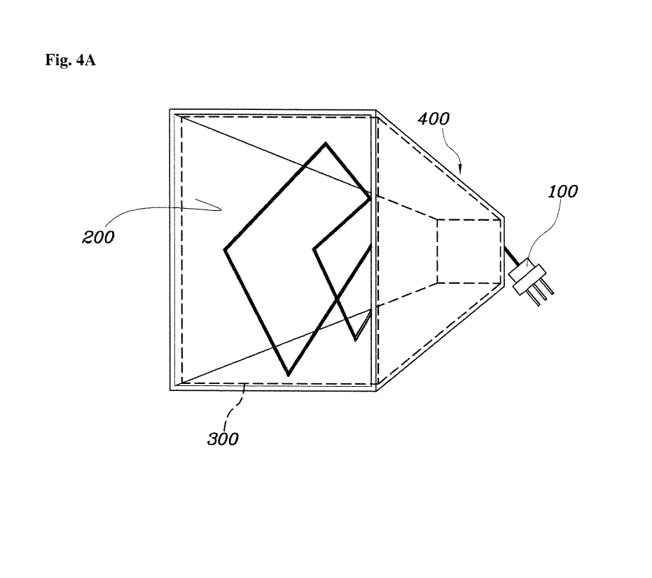

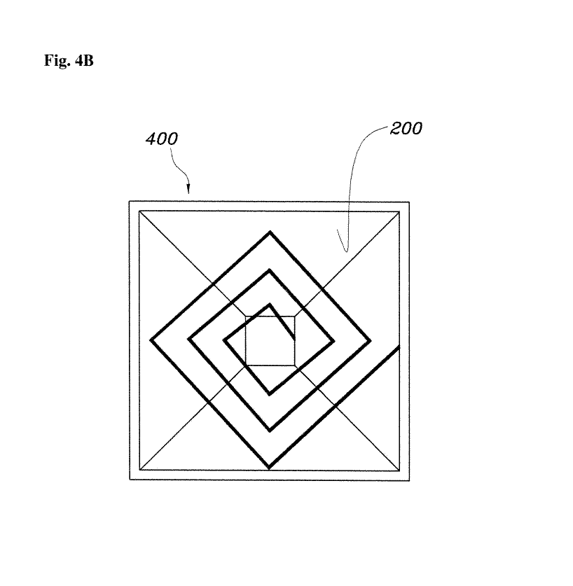

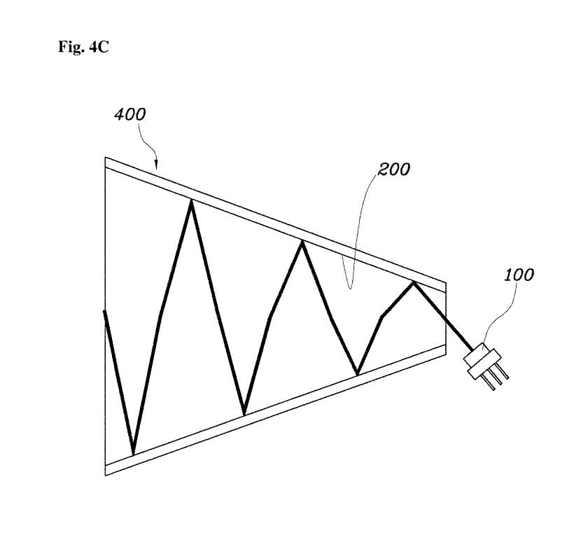

FIGS. 4A to 4C show the vehicle lamp according to the fourth embodiment of the present inventive concept. FIG. 4A is a perspective view of the vehicle lamp according to the fourth embodiment of the present inventive concept, FIG. 4B is a front view of the vehicle lamp of FIG. 4A, and FIG. 4C is a side view of the vehicle lamp of FIG. 4A.

In the fourth embodiment, the housing 400 may have an increasing cross-sectional area toward a front. As shown in FIG. 4C, since light from the light source 100 passes a center of each surface and the side surface of the housing 400 is inclined, an incident angle of light radiated forward may vary according to reflection of the light from the side surface.

In addition to the shapes described in the first to fourth embodiments, the housing 400 may have various shapes such as a polygonal shape or a circular shape at the side surface thereof, and have a length in forward and rearward directions. In addition, the reflector 200 may be provided on each surface along an entire or partial length. Various shapes of the set pattern may be realized according to the polygonal shape by provision of the reflector 200 for each surface of the polygonal-shaped housing.

The housing 400 may further have a light receiving portion (not shown) to receive light from the light source 100 at a position at which the light from the light source 100 finally reaches the inner wall portion of the housing 400 and prevent the light from being reflected from the position any more.

The light receiving portion may be a pad for absorption of light or a hole formed on the housing 400 so as to prevent light from the light source 100 from being reflected any more.

The light receiving portion may be provided at a front end portion of the housing 400, but the present disclosure is not limited thereto. For example, the light receiving portion may be installed at a position for blocking movement of light in the housing according to a driver's intention, i.e., at any position at which light finally reaches according to the driver's intention.

In accordance with the vehicle lamp having the above-mentioned structure, it may be possible to accomplish reduction of cost and improvement of aesthetics since the 3D lamp is realized using one light source.

In addition, the various patterns may be generated according to the incident angle of light from the light source and the installation position of the reflector, thereby enabling the product value of the vehicle to be significantly increased at low cost.

In accordance with a vehicle lamp according to the exemplary embodiments of the present inventive concept, it may be possible to accomplish reduction of cost and improvement of aesthetics at the same time since a 3D lamp can be applied using one light source.

In addition, various patterns may be generated according to an incident angle of light from the light source and an installation position of a reflector.

While the present inventive concept has been described with respect to the specific embodiments, it will be apparent to those skilled in the art that various changes and modifications may be made without departing from the spirit and scope of the invention as defined in the following claims.

What is claimed is:

1. A vehicle lamp comprising:
a light source for generating light which has a set movement path;
at least one reflector provided on the movement path of the light generated by the light source; and
a scatterer disposed on the movement path of the light generated by the light source to scatter the light such that the movement path of the light is visible.

2. The vehicle lamp of claim 1, wherein the light source generates laser beams.

3. The vehicle lamp of claim 1, wherein the reflector is provided in plural numbers, and the plurality of reflectors are arranged in a set pattern formed by the movement path of the light.

4. The vehicle lamp of claim 3, wherein the set pattern is provided in plural numbers, and the plurality of set patterns have a continuously and repeatedly form.

5. The vehicle lamp of claim 1, wherein the scatterer is in a form of any one of gas, liquid, solid, and gel, the scatterer including particles for scattering the light.

6. The vehicle lamp of claim 1, comprising a housing of which an inner wall surface is provided with the reflector,
wherein the scatterer is filled in the housing and the movement path of the light is formed in the scatterer along the reflector.

7. The vehicle lamp of claim 6, wherein the housing is sealed and has a transparent front surface, the light from the light source is incident on a rear surface of the housing, and the reflector is provided at a side surface of the housing.

8. The vehicle lamp of claim 7, wherein all of the front, rear, and side surfaces of the housing are transparent.

9. The vehicle lamp of claim 7, wherein the reflector is installed to entirely cover the rear surface and the side surface of the inner wall surface of the housing.

10. The vehicle lamp of claim 6, wherein the housing has a polygonal shape at the side surface thereof and has a length in forward and rearward directions, and the reflector is provided on each surface of the polygonal-shaped side surface along an entire or partial length of the housing.

11. The vehicle lamp of claim 6, wherein the reflector is mounted to the inner wall surface of the housing.

12. The vehicle lamp of claim 6, wherein the housing is further provided with a light receiving portion to receive light from the light source at a position at which the light from the light source reaches the inner wall surface of the housing and to prevent the light from being reflected from the position.

13. The vehicle lamp of claim 2, wherein the light source is a laser diode.

14. The vehicle lamp of claim 3, wherein the set pattern is formed according to a position of the reflector, an incident angle of the light in the reflector, and a position of the light source.

15. The vehicle lamp of claim 3, wherein the set pattern has a square shape, a diamond shape, or a start shape.

16. The vehicle lamp of claim 6, wherein the housing has an increasing cross-sectional area toward a front side thereof.

17. The vehicle lamp of claim 6, wherein the light receiving portion is a pad for absorbing the light or is a hole formed on the housing.
